(19) United States
(12) Patent Application Publication
(10) Pub. No.: US 2013/0284123 A1
(43) Pub. Date: Oct. 31, 2013

(54) ENERGY RECOVERY SYSTEM FOR A MOBILE MACHINE

(71) Applicant: Aaron Gamache FOEGE, Westmont, IL (US)

(72) Inventor: Aaron Gamache FOEGE, Westmont, IL (US)

(21) Appl. No.: 13/459,373

(22) Filed: Apr. 30, 2012

(51) Int. Cl. F02B 73/00; F02C 3/22; F17C 9/02

(52) U.S. Cl. 123/2; 62/48.1; 60/39.465; 60/772

(57) ABSTRACT

The disclosure is directed to an energy recovery system for a mobile machine. The energy recovery system may include a tank configured to store a liquid fuel for combustion within an engine of the mobile machine, and a combustor selectively connectable to receive gaseous fuel formed in the tank. The energy recovery system may also include a recovery device operable to generate work using exhaust from the combustor.

### TECHNICAL FIELD

The present disclosure relates generally to a recovery system, and more particularly, to an energy recovery system for a mobile machine.

### BACKGROUND

Natural gas has been used an alternative fuel for internal combustion engines in mobile machines. Because natural gas has a lower energy density than traditional fuels such as diesel and gasoline, mobile machines generally utilize liquefied natural gas (“LNG”). At atmospheric pressures, natural gas must be chilled to below about −160° C. to remain in liquid form. Mobile machines utilizing LNG as a fuel store the LNG in insulated tanks. Because these tanks are not perfect insulators, heat enters the tank, causing some of the LNG to boil (“boil-off”). The boil-off increases the pressure of the tank, and can cause the tank to explode if not removed. Traditional LNG systems vent the boil-off (composed mostly of methane) directly to the atmosphere. However, because methane is a greenhouse gas, government regulations no longer permit the direct venting of boil-off to the atmosphere.

One method of handling boil-off from an LNG tank is described in U.S. Patent Publication No. 2008/0053349 (“the '349 publication”) of O'Connor that published on Mar. 6, 2008. The '349 publication describes a marine vessel having a tank for storing LNG. The '349 publication delivers boil-off gas from the tank to a combustion section via a gas inlet. Combustion air is also directed to the combustion section and the resulting air-gas mixture is ignited. This system effectively converts the boil-off to carbon dioxide and water, which are less harmful to the environment.

Although the system of the '349 publication may be capable of preventing boil-off from directly venting to the atmosphere, it may be wasteful. Specifically, because the system of the '349 publication only combusts the boil-off, energy associated with the boil-off is lost from the system as heat and exhaust.

The energy recovery system of the present disclosure solve one or more of the problems set forth above and/or other problems with existing technologies.

### SUMMARY

In one aspect, the disclosure is directed to an energy recovery system for a mobile machine. The energy recovery system may include a tank configured to store a liquid fuel for combustion within an engine of the mobile machine, and a combustor selectively connectable to receive gaseous fuel formed in the tank. The energy recovery system may also include a recovery device operable to generate work using exhaust from the combustor.

In another aspect, the disclosure is directed to a method of operating a mobile machine. The method may include drawing liquid fuel from a tank for combustion within an engine of the mobile machine. The method may also include directing gaseous fuel formed in the tank to a combustor, and selectively using exhaust from the combustor to power an energy recovery device.

### BRIEF DESCRIPTION OF THE DRAWINGS

FIG. 1 is a pictorial illustration of an exemplary disclosed mobile machine;

FIG. 2 is a diagrammatic illustration of an exemplary disclosed energy recovery system that may be used in conjunction with the mobile machine of FIG. 1; and

FIG. 3 is a flowchart depicting an exemplary disclosed method of controlling the energy recovery system of FIG. 2.

### DETAILED DESCRIPTION

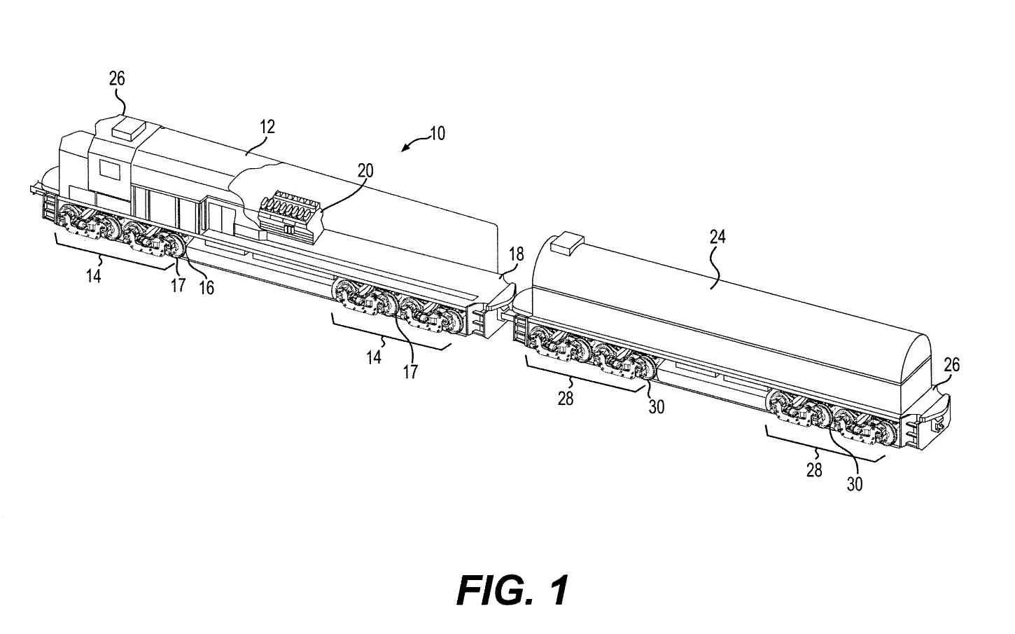

FIG. 1 illustrates an exemplary embodiment of a mobile machine 10, such as a locomotive, that includes a car body 12 supported at opposing ends by a plurality of trucks 14 (e.g., two trucks 14). Each truck 14 may be configured to engage a track 16 via a plurality of wheels 17, and support a frame 18 of car body 12. Any number of engines may be mounted to frame 18 and configured to produce electricity that drives wheels 17 included within each truck 14. In the exemplary embodiment shown in FIG. 1, mobile machine 10 includes an engine 20.

Mobile machine 10 may also include a tank 24 configured to store a liquid fuel for combustion within engine 20. Tank 24 may be an insulated, single or multi-walled tank configured to store a liquid fuel at low temperatures, such as below about −160° C. Tank 24 may be mounted to a frame 26 configured to be pulled by mobile machine 10. Frame 26 may be supported by a plurality of trucks 28 (e.g., two trucks 28). Similar to truck 14, each truck 28 may be configured to engage track 16 via a plurality of wheels 30. Alternatively, tank 24 may be mounted to frame 18, if desired.

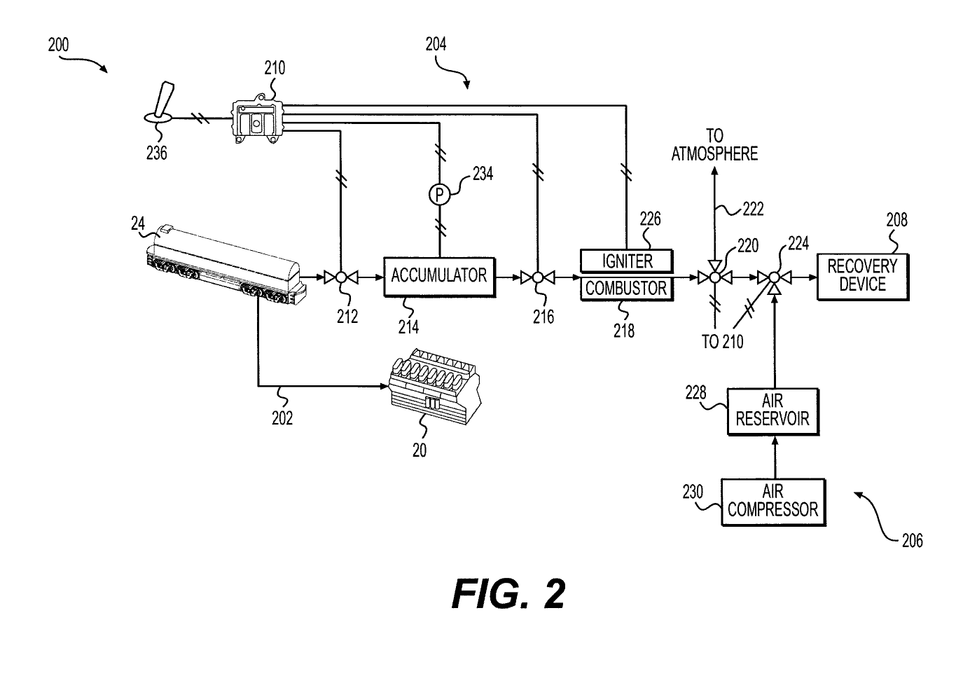

As shown in FIG. 2, mobile machine 10 may be equipped with an energy recovery system (“system”) 200 that is configured to generate work by combusting boil-off gas formed in tank 24. System 200 may include, among other things, a fuel delivery circuit 202, a boil-off circuit 204, and a compressed air circuit 206. System 200 may also include a recovery device 208. Fuel, compressed air, and/or exhaust flows to recovery device 208 may be regulated through fuel delivery, boil-off, and compressed air circuits 202, 204, and 206 by a controller 210.

Fuel delivery circuit 202 may include components that cooperate to deliver a liquid fuel stored in tank 24 to engine 20. Fuel delivery circuit 202 may include, among other things, conventional pumps, conduits, heat exchangers, accumulators, and injectors configured to condition and deliver low-temperature liquid fuel from tank 24 to engine 20 in gaseous form, as is known in the art. During this conditioning and delivery, some fuel within tank 24 may evaporate into a gaseous fuel.

Boil-off circuit 204 may include components that cooperate to process the gaseous fuel formed within tank 24. In particular, boil-off circuit 204 may include a control valve 212, an accumulator 214, a control valve 216, a combustor 218, a control valve 220, an exhaust conduit 222, and a control valve 224. Gaseous fuel may flow from tank 24 through control valve 212 to accumulator 214. From accumulator 214, gaseous fuel may flow through control valve 216 to combustor 218, where it may be mixed with inlet air and combusted. Exhaust from combustor 218 may be directed to the atmosphere via exhaust passage 222 or through control valve 224 to recovery device 208.

Control valve 212 may be a controllable pressure-relief valve configured to selectively allow fluid communication between tank 24 and accumulator 214. When control valve 212 opens, it may allow gaseous fuel to escape tank 24 and flow to accumulator 214. Control valve 212 may include a spring-loaded mechanism (not shown) that opens control valve 212 at a predetermined pressure to avoid over-pressurization of tank 24. Additionally or alternatively, control valve 212 may include one or more controllable actuators, such as one or more electric solenoids that are operable to open control valve 212 when activated. Controller 210 may be operatively connected to the actuator(s) of control valve 212, so that controller 210 may selectively trigger opening and closing of control valve 212 to release gaseous fuel and pressure from tank 24.

Accumulator 214 may embody, for example, a compressed gas, membrane/spring, bladder-type, or another suitable accumulator configured to accumulate pressurized gaseous fuel and discharge the fuel to combustor 218 via control valve 216. Gaseous fuel from tank 24 may be directed into accumulator 24 via control valve 212.

Control valve 216 may be substantially similar to control valve 212, but may be configured to selectively allow fluid communication between accumulator 214 and combustor 218. When control valve 216 opens, it may allow gaseous fuel to escape accumulator 214 and flow to combustor 218. Control valve 216 may include a spring-loaded mechanism (not shown) that opens control valve 216 at a predetermined pressure to avoid over-pressurization of accumulator 214. Additionally or alternatively, control valve 216 may include one or more controllable actuators, such as one or more electric solenoids that are operable to open control valve 216 when actuated. Controller 210 may be operatively connected to the actuator(s) of control valve 216, so that controller 210 may selectively trigger opening and closing of control valve 216 to release gaseous fuel and pressure from accumulator 214.

Combustor 218 may be configured to combust a mixture of air and gaseous fuel to produce exhaust at a high pressure, temperature, and velocity. Combustor 218 may include an igniter 226 configured to regulate the combustion of a fuel and air mixture within combustor 218 during a series of ignition sequences. Igniter 226 may include any known ignition components, such as an ignition coil, one or more auxiliary injectors, and a power source, if desired. Controller 210 may be in communication with igniter 226, and may activate igniter 226 when control valve 216 is actuated. Exhaust resulting from the combustion process within combustor 218 may be directed to control valve 220.

Control valve 220 may be a proportional type valve having a valve element movable to regulate a flow of exhaust from combustor 218. The valve element may be solenoid-operable to move between a flow-passing position and a flow-blocking position. In the flow-passing position, control valve 220 may permit substantially all of the exhaust to flow through control valve 224 to recovery device 208. In the flow-blocking position, control valve 220 may completely block exhaust from flowing through control valve 224 to recovery device 208, while diverting substantially all the exhaust to the atmosphere via exhaust conduit 222. Control valve 220 may also include an intermediate position between the flow-passing position and the flow-blocking position. In the intermediate position, control valve 220 may permit some of the exhaust to flow through control valve 224 to recovery device 208, while diverting a remaining portion of the exhaust to the atmosphere via exhaust conduit 222.

Control valve 224 may be a proportional type valve having a valve element movable to regulate a flow of fluid to recovery device 208 from boil-off circuit 204, from compressed air circuit 206, or from both boil-off circuit 204 and compressed air circuit 206. The valve element may be solenoid-operable to move between a first position, a second position, and a third position. In the first position, control valve 224 may pass exhaust from boil-off circuit 204 to recovery device 208. In the second position, control valve 224 may completely block exhaust from boil-off circuit 204 while diverting compressed air from compressed air circuit 206 to recovery device 208. In the third position, control valve 224 may block flow from both boil-off circuit 204 and compressed air circuit 206. It is contemplated that control valve 224 may have a fourth position, if desired, at which control valve 224 allows for simultaneous flows from boil-off circuit 204 and compressed air circuit 206 to recovery device 208.

Compressed air circuit 206 may include an air reservoir 228 and an air compressor 230. Air reservoir 228 may include a housing and may be made from any material capable of holding compressed air such as, for example, steel, alloys, or other metals. Air compressor 230 may be a stand-alone component that is either mechanically or electrically driven by engine 20. In an alternative embodiment, air compressor 230 may be part of an existing air induction system that also supplies compressed air to engine 20, for example a compressor portion of an engine turbocharger.

Recovery device 208 may be any device operable to accept a pressurized gas to generate work. In one embodiment, recovery device 208 may be a horn configured to generate a warning signal using exhaust from combustor 218 and/or compressed air from compressed air circuit 206. Additionally or alternatively, recovery device 208 may include other components that may be configured to receive a pressurized gas to perform a function such as a turbine, a windshield wiper, pneumatic control valves, and brakes, among others.

Controller 210 may be a single microprocessor or multiple microprocessors that include a mechanism for controlling an operation of recovery system 200. Numerous commercially available microprocessors can be configured to perform the functions of controller 210. It should be appreciated that controller 210 could readily be embodied in a general engine or machine microprocessor capable of controlling numerous engine and/or machine functions. Controller 210 may include a memory, a secondary storage device, a processor, and any other components for running an application. Various other circuits may be associated with controller 210 such as power supply circuitry, signal conditioning circuitry, solenoid driver circuitry, and other types of circuitry.

Controller 210 may rely on input from one or more sensors during regulation of recovery system 200. In the disclosed exemplary embodiment, controller 210 may rely on at least one sensor 234 configured to measure a pressure of accumulator 214, although any number and types of sensors may be utilized. Sensor 234 may embody, for example, a pressure sensor configured to generate a signal indicative of a pressure of accumulator 214. Sensor 234 may direct a corresponding signal to controller 210 for further processing. Controller 210 may also rely on input from an operator interface device 236 that an operator may use to activate recovery device 208. For example, operator interface device 236 may be moved from an “OFF” position to an “ON” position, and may send a signal to controller 210 while in the “ON” position for further processing.

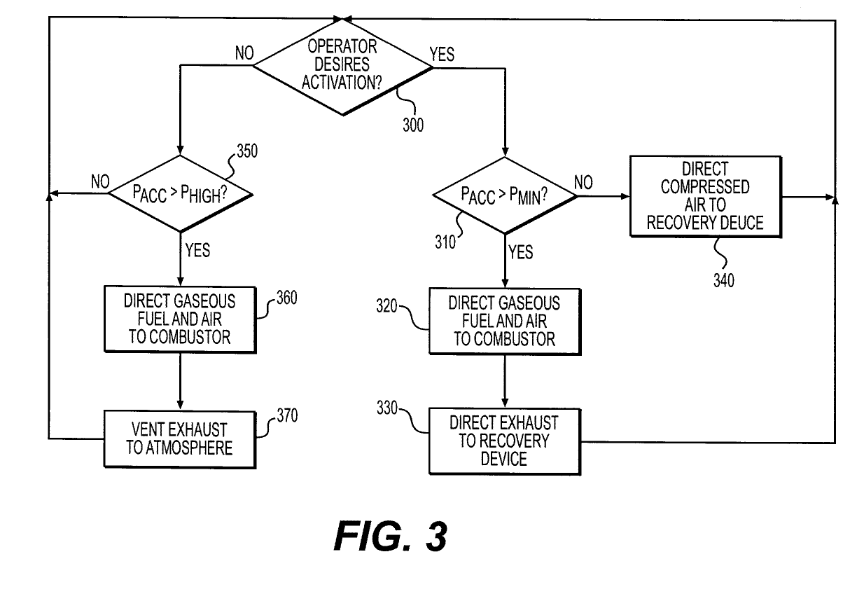

FIG. 3 illustrates an exemplary energy recovery process performed by controller 210. FIG. 3 will be discussed in more detail in the following section to better illustrate the disclosed concepts.

### INDUSTRIAL APPLICABILITY

The disclosed energy recovery system may be applicable to any mobile machine utilizing a low-temperature liquid fuel. The disclosed energy recovery system may enhance fuel efficiency by using gaseous fuel formed in a liquid fuel tank to perform work functions typically performed by a compressed air system. Operation of recovery system 200 will now be described.

Controller 210 may determine when an operator desires activation of recovery device 208 based on the position of operator interface device 136 (step 300). When controller 210 determines that operator interface device 136 is in the “ON” position, controller 210 may proceed to step 310.

At step 310, controller 210 may receive input from sensor 234 indicative of a pressure of accumulator 214. Controller 210 may then determine if the pressure of accumulator 214 is higher than a low-pressure threshold. The low-pressure threshold may be associated with an amount of gaseous fuel stored in accumulator 214 sufficient to operate recovery device 208. When the accumulator pressure is higher than the low-pressure threshold, controller 210 may move control valve 216 to the flow-passing position and direct gaseous fuel from accumulator 214 to combustor 218 (step 320). Also at step 320, controller 210 may send a signal to igniter 226 to ignite gaseous fuel received by combustor 218.

During and after combustion of gaseous fuel in combustor 218, controller 210 may move control valve 220 to the flow passing position and control valve 224 to the first position to direct high-pressure exhaust to recovery device 208 (step 330). Recovery device 208 may use the high-pressure exhaust from combustor 218 to perform a function typically driven by compressed air system 206, such as generating a warning signal via a horn, spinning a turbine to produce electricity, driving a windshield wiper, driving pneumatic valves, and powering brakes, among others. From step 330, controller 210 may return to step 300.

If at step 310, controller 210 instead determines that the accumulator pressure is lower than the low-pressure threshold, controller 210 may proceed to step 340. At step 340, controller 210 may direct compressed air from air reservoir 228 (or a mixture of exhaust and air) through control valve 224 to recovery device 208. That is, controller 210 may send a signal to control valve 224 to move to the second position to allow compressed air to flow to recovery device 208. Air compressor 230 may generate additional compressed air to maintain a minimum threshold pressure of air reservoir 228. Recovery device 208 may use the compressed air from air reservoir 228 to perform substantially the same functions as in step 320. From step 340, controller 210 may return to step 300.

When controller 210 determines at step 300 that operator interface device 236 is in the “OFF” position, controller 210 may proceed to step 350. At step 350, controller 210 may receive input from sensor 234 indicative of a pressure of accumulator 214. Controller 210 may then determine if the pressure of accumulator 214 is higher than a high-pressure threshold. The high-pressure threshold may be associated with a capacity of accumulator 214 to store additional gaseous fuel. If the accumulator pressure is higher than the high-pressure threshold, controller 210 may move control valve 216 to the flow-passing position to direct gaseous fuel from accumulator 214 to combustor 218 (step 360). Also at step 360, controller 210 may send a signal to igniter 226 to ignite gaseous fuel received by combustor 218.

From step 360, controller 210 may proceed to step 370. At step 370, during and after the combustion of gaseous fuel in combustor 218, controller 210 may move control valve 220 to the flow-blocking position to divert high-pressure exhaust from combustor 218 to the atmosphere via exhaust conduit 222. From step 370, controller 210 may return to step 300.

The disclosed energy recovery system 200 may provide a mechanism for improving fuel efficiency of mobile machine 10. For example, the disclosed energy recovery system 200 may use high-pressure exhaust from the combustion of boil-off gas to perform functions typically associated with compressed air circuit 206. Energy recovery system 200 may thus utilize energy from boil-off gas that otherwise would be lost, and reduce liquid fuel consumption by reducing the amount of energy directed to compressed air circuit 206.

It will be apparent to those skilled in the art that various modifications and variations can be made to the disclosed energy recovery system without departing from the scope of the disclosure. Other embodiments of the energy recovery system will be apparent to those skilled in the art from consideration of the specification and practice of the energy recovery system disclosed herein. It is intended that the specification and examples be considered as exemplary only, with a true scope of the disclosure being indicated by the following claims and their equivalents.

What is claimed is:

1. An energy recovery system for a mobile machine, comprising:
a tank configured to store a liquid fuel for combustion within an engine of the mobile machine;
a combustor selectively connectable to receive gaseous fuel formed in the tank; and
a recovery device operable to generate work using exhaust from the combustor.

2. The energy recovery system of claim 1, further including an accumulator fluidly connected to the tank and configured to store gaseous fuel formed in the tank.

3. The energy recovery system of claim 2, further including a first valve associated with the tank and configured to discharge gaseous fuel from the tank to the accumulator when a pressure of the tank exceeds a tank threshold pressure.

4. The energy recovery system of claim 3, further including a second valve located between the accumulator and the combustor, the second valve being configured to move to a flow-passing position when a pressure of the accumulator exceeds an accumulator threshold pressure.

5. The energy recovery system of claim 4, further including:
a sensor configured to generate a signal indicative of the pressure of the accumulator; and
a controller configured to activate the second valve based on the signal.

6. The energy recovery system of claim 4, further including:
an igniter associated with the combustor; and
a controller configured to activate the igniter when the second valve is in the flow-passing position.

7. The energy recovery system of claim 4, wherein the recovery device is a horn configured to generate a warning signal using the exhaust from the combustor.

8. The energy recovery system of claim 7, further including:
an air reservoir configured to hold a supply of compressed air;
a third valve connected downstream of the combustor and the air reservoir and upstream of the horn;
a sensor configured to generate a signal indicative of a pressure of the accumulator; and
a controller configured to:
move the second valve to a flow-passing position when the pressure of the accumulator is greater than a low-pressure threshold;
move the third valve to direct exhaust from the combustor through the horn when the second valve is in the flow-passing position; and
move the third valve to direct compressed air through the horn when the pressure of the accumulator is lower than the low-pressure threshold.

9. The energy recovery system of claim 8, further including:
an operator interface device movable between an on-position and an off-position; and
a fourth valve configured to direct exhaust from the combustor to the horn or to atmosphere,
wherein the controller is further configured to:
move the fourth valve to direct exhaust from the combustor to the horn only when the operator interface device is in the on position; and
move the fourth valve to direct exhaust from the combustor to atmosphere when the operator interface device is in the off position.

10. A method of operating a mobile machine, comprising:
drawing liquid fuel from a tank for combustion within an engine of the mobile machine;
directing gaseous fuel formed in the tank to a combustor; and
selectively directing exhaust from the combustor to a recovery device to generate work.

11. The method of claim 10, wherein directing gaseous fuel from the tank to the combustor includes directing gaseous fuel to the combustor when a pressure of the tank exceeds a threshold pressure.

12. The method of claim 10, further including:
accumulating gaseous fuel formed in the tank; and
directing accumulated gaseous fuel to the combustor.

13. The method of claim 12, wherein directing accumulated gaseous fuel to the combustor includes directing accumulated gaseous fuel to the combustor when a pressure of the accumulated gaseous fuel exceeds a threshold pressure.

14. The method of claim 13, further including igniting gaseous fuel in the combustor.

15. The method of claim 12, further including:
receiving operator input indicative of a desire to activate the recovery device; and
selectively directing accumulated gaseous fuel to the combustor based on the operator input.

16. The method of claim 15, further including directing exhaust from the combustor to atmosphere when the activation of the recovery device is not desired by the operator.

17. The method of claim 12, wherein:
the recovery device a horn; and
the method further includes:
determining a pressure of the accumulated gaseous fuel;
directing the accumulated gaseous fuel to the combustor when the pressure exceeds a low-pressure threshold;
directing exhaust from the combustor to the horn to generate a warning signal when the pressure exceeds the low-pressure threshold; and
directing compressed air to the horn when the pressure is below the low pressure threshold.

18. A mobile machine, comprising:
a frame;
an engine mounted to the frame;
wheels configured to support the frame and driven by the engine;
a tank configured to store a liquid fuel for combustion within the engine;
an accumulator fluidly connected to the tank and configured to store gaseous fuel formed in the tank;
a combustor selectively connectable to receive gaseous fuel from the accumulator;
a horn operable to generate a warning signal using exhaust from the combustor;
a first valve associated with the tank and configured to discharge gaseous fuel from the tank into the accumulator when a pressure of the tank exceeds a tank threshold pressure;
a second valve located between the accumulator and the combustor and configured to move to a flow-passing position when a pressure of the accumulator exceeds an accumulator threshold pressure;
an air reservoir configured to hold a supply of compressed air;
a third valve connected downstream of the combustor and the air reservoir and upstream of the horn;
a sensor configured to generate a signal indicative of a pressure of the accumulator; and
a controller configured to:
move the second valve to the flow-passing position only when the pressure of the accumulator is greater than a low-pressure threshold;
move the third valve to direct exhaust from the combustor through the horn when the second valve is in the flow-passing position; and
move the third valve to direct compressed air through the horn when the pressure of the accumulator is lower than the low-pressure threshold.

19. The mobile machine of claim 18, further including:
an operator interface device movable between an on-position and an off-position; and
a fourth valve configured to direct exhaust to the horn or to atmosphere,
wherein the controller is further configured to:
move the fourth valve to direct exhaust from the combustor to the horn only when the operator interface device is in the on-position; and
move the fourth valve to direct exhaust from the combustor to atmosphere when the operator interface device is in the off-position.

20. The mobile machine of claim 18, further including an igniter associated with the combustor, wherein the controller is further configured to activate the igniter when the second valve is in the flow-passing position.
